(19) United States
(12) Patent Application Publication
(10) Pub. No.: US 2026/0276122 A1
(43) Pub. Date: Sep. 17, 2026

(54) Connector Assembly and Energy Storage Device Including the Same

(71) Applicant: Illinois Tool Works Inc., Glenview, IL (US)

(72) Inventor: Cong Cao, Shanghai (CN)

(21) Appl. No.: 19/562,406

(22) Filed: Mar. 10, 2026

(30) Foreign Application Priority Data
Mar. 14, 2025 (CN) 2025204622214

(51) Int. Cl. F16L 29/04

(52) U.S. Cl. CPC F16L 29/04

(57) ABSTRACT

A connector assembly includes a male connector and a female connector aligned along an axial direction. The male connector has an outer valve core, and the female connector has a corresponding outer valve core that contacts the male valve core during connection. Each valve core carries a limiting structure. The limiting structures engage each other to restrict radial movement of the female valve core relative to the male valve core. When the connectors separate, an elastic element moves the female valve core axially back to an initial position. The cooperating limiting structures guide movement of the valve cores and prevent radial displacement, which improves alignment, supports reliable operation, and promotes consistent return of the female valve core after disconnection.

### RELATED APPLICATION

The present application claims the benefit of Chinese Patent Application No. 2025204622214, filed Mar. 14, 2025, titled “Connector Assembly and Energy Storage Device Including the Same,” the contents of which are hereby incorporated by reference.

### TECHNICAL FIELD

The present disclosure relates to the field of connector technology, and more particularly, to a connector assembly and an energy storage device including the same.

### BACKGROUND

In application environments such as energy storage, supercharging, hydrogen production, or data centers, connectors are typically required to connect pipelines. A bidirectional shut-off connector assembly is a commonly used connector assembly. A bidirectional shut-off connector assembly usually includes a female connector and a male connector, which are connected to the two pipelines to be joined, respectively. The bidirectional shut-off function is achieved through the cooperation design of the female and male connectors. Traditional bidirectional shut-off connector assemblies use valve cores and sealing structures inside the female and male connectors. When the female and male connectors are separated, they automatically close to prevent fluid leakage, and when the female and male connectors are connected, they open to allow fluid passage.

In some existing bidirectional shut-off connector assemblies, both the female and male connectors contain valve cores connected to elastic elements. When the female and male connectors are not connected, springs within them push their respective valve cores to the closed position, causing each valve core to closely contact the corresponding seal, preventing fluid leakage from the ends of the female and male connectors, thus achieving bidirectional shut-off. When the female and male connectors are connected, the valve cores inside them interact, pushing the valve cores to overcome the spring force and open, forming a fluid passage allowing fluid flow.

### SUMMARY OF THE DISCLOSURE

The present disclosure relates generally to a valve, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a bidirectional shut-off connector assembly according to an embodiment of the present disclosure from one perspective.

FIG. 1B is an exploded view of the bidirectional shut-off connector assembly of FIG. 1A from another perspective.

FIG. 2A is an exploded view of the female connector in FIG. 1A from one perspective.

FIG. 2B is an exploded view of the female connector in FIG. 1A from another perspective.

FIG. 2C is an axial cross-sectional view of the female connector in FIG. 1A.

FIG. 3A is an exploded view of the male connector in FIG. 1A from one perspective.

FIG. 3B is an axial cross-sectional view of the male connector in FIG. 1A.

FIG. 4A shows an axial cross-sectional view of the bidirectional shut-off connector assembly when the male connector has not yet been inserted into the female connector.

FIG. 4B shows an axial cross-sectional view of the bidirectional shut-off connector assembly during insertion of the male connector into the female connector.

FIG. 4C shows an axial cross-sectional view of the bidirectional shut-off connector assembly after the male connector is inserted in place into the female connector.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The term “male connector” means a connector for active insertion, and the “female connector” in the present disclosure refers to a connector for passive reception.

The term “first direction” means the insertion direction in which the male connector is inserted into the female connector.

The term “second direction” means the direction opposite the first direction, i.e., the direction in which the male connector is withdrawn from the female connector.

Through in-depth research, it has been found that in some existing connector assemblies, such as bidirectional shut-off connector assemblies, when the male and female connectors are disconnected after being connected, the valve core of the female connector has difficulty returning to the closed position, preventing the bidirectional shut-off connector assembly from achieving the bidirectional shut-off state again.

The present disclosure provides a connector assembly having an axial direction and a radial direction and including a male connector and a female connector. The male connector includes a male connector outer valve core. The female connector includes a female connector outer valve core, and the female connector outer valve core abuts against the male connector outer valve core along the axial direction. The male connector outer valve core includes a male connector limiting portion, and the female connector outer valve core includes a female connector limiting portion. The male connector limiting portion is configured to engage with the female connector limiting portion to restrict movement of the female connector outer valve core relative to the male connector outer valve core in the radial direction. The structural arrangement of the male and female connector limiting portions allows them to remain engaged when the male connector outer valve core moves axially in a first direction, and allows the male connector limiting portion to disengage from the female connector limiting portion when the male connector outer valve core moves axially in a second direction opposite the first direction.

In some examples, the connector assembly is a bidirectional shut-off connector assembly. Movement of the male connector outer valve core in the first direction can open the bidirectional shut-off connector assembly, and movement of the male connector outer valve core in the second direction can close the bidirectional shut-off connector assembly.

In some examples, the female connector limiting portion is provided at an axial end of the female connector outer valve core facing the male connector outer valve core, and the male connector limiting portion is provided at an axial end of the male connector outer valve core facing the female connector outer valve core.

In some examples, the female connector limiting portion is provided at an end surface of the axial end of the female connector outer valve core, and the male connector limiting portion is provided at an end surface of the axial end of the male connector outer valve core.

In some examples, one of the female connector limiting portion and the male connector limiting portion has a protruding shape, and the other of the female connector limiting portion and the male connector limiting portion has a recessed shape.

In some examples, one of the female connector limiting portion and the male connector limiting portion is an annular protrusion, and the other of the female connector limiting portion and the male connector limiting portion is an annular groove.

In some examples, the female connector includes a female connector housing, the female connector housing including a female connector first outer housing, a female connector second outer housing, and a female connector inner housing. The female connector first and second outer housings are connected together, and the female connector inner housing is detachably connected inside the female connector first and second outer housings. The female connector outer valve core is inside the female connector inner housing.

In some examples, the female connector inner housing has an inner housing limiting portion provided at an end of the female connector inner housing close to the male connector and capable of abutting against an outer surface of the female connector outer valve core.

In some examples, the inner housing limiting portion is an annular protrusion.

The present disclosure also provides an energy storage device including the aforementioned connector assembly.

Compared with the prior art, the connector assembly of the present disclosure, by providing cooperating limiting structures on the valve cores of the male and female connectors, restricts the female connector outer valve core from moving radially, enabling the female connector outer valve core to return axially to a female connector first position under the action of an elastic element when the male and female connectors are disconnected again.

The connector assembly of the present disclosure, by providing cooperating limiting structures on the valve cores of the male and female connectors, does not need to rely on the female connector housing to restrict radial movement of the female connector outer valve core, which can reduce the length of the female connector housing, enabling the connector assembly to have a smaller size.

Furthermore, the female connector housing of the connector of the present disclosure includes a female connector inner housing for retaining the female connector outer valve core, a female connector inner valve core, and a female connector elastic element in place, allowing the female connector inner housing, the female connector outer valve core, the female connector inner valve core, and the female connector elastic element to be assembled together as a module. This not only facilitates assembly but also allows convenient replacement of female connector first and second outer housings of different shapes as needed.

Moreover, the connector assembly of the present disclosure is particularly suitable for application scenarios requiring multiple shut-offs and connections, such as energy storage devices.

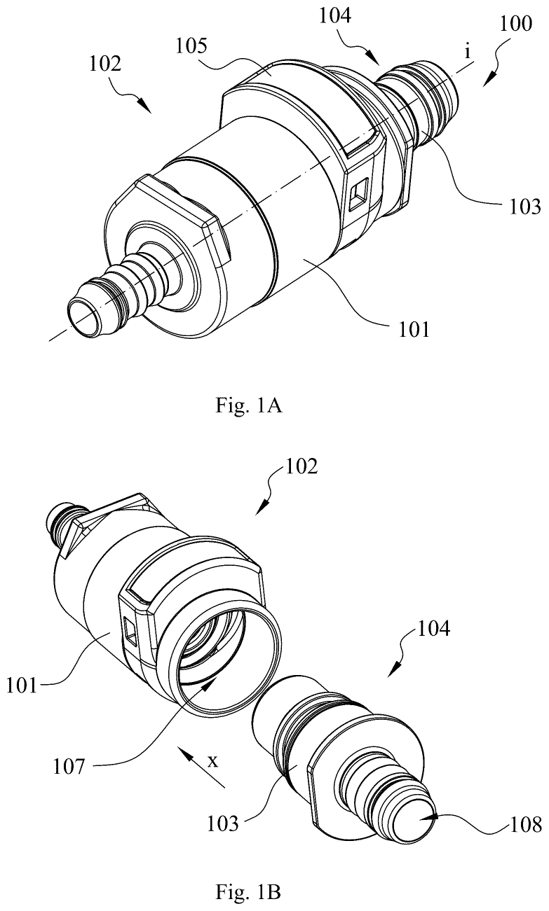

FIG. 1A and FIG. 1B show the general structure of a bidirectional shut-off connector assembly 100 according to an embodiment of the present disclosure. FIG. 1A shows a perspective structural view of the bidirectional shut-off connector assembly 100 viewed from front to back, and FIG. 1B shows an exploded view of the bidirectional shut-off connector assembly 100 viewed from back to front, with the male connector 104 separated from the female connector 102. Although a bidirectional shut-off connector assembly is described as an example in this embodiment, those skilled in the art will understand that the connector assembly of the present disclosure can also be other types of connector assemblies. As shown in FIGS. 1A and 1B, the bidirectional shut-off connector assembly 100 includes a male connector 104 and a female connector 102. The male connector 104 and the female connector 102 are connected in a plug-in manner, i.e., the male connector 104 is partially inserted into the female connector 102. When the male connector 104 and the female connector 102 are connected, they are in fluid communication. When the male connector 104 and the female connector 102 are not connected, both the male connector 104 and the female connector 102 are shut off, preventing fluid passage.

The female connector 102 is generally a straight cylinder with a circular cross-section. To adapt to different application environments, in other embodiments, the female connector 102 may also be a bent pipe shape or a cylinder with other cross-sectional shapes. The female connector 102 includes a female connector housing 101. The inner diameter at the rear end of the female connector housing 101 for receiving the male connector 104 matches the outer diameter of the male connector 104, so that the male connector 104 can be inserted exactly into the female connector 102. In this embodiment, the front end of the female connector housing 101 is provided with external threads, so that the female connector 102 can be threadedly connected to an external pipeline (not shown) via the external threads. In other embodiments, the female connector 102 can also be connected to an external pipeline in other ways, such as by clamp connection, etc. The female connector 102 defines a female connector channel 107 passing therethrough. The front end of the female connector channel 107 is for fluid communication with an external pipeline (not shown), and the female connector 102 receives and fixes the male connector 104 through the rear end of the female connector channel 107.

The male connector 104 is generally a straight cylinder with a circular cross-section. Similar to the female connector 102, to adapt to different application environments, in other embodiments, the male connector 104 can also be a bent pipe shape or a cylinder with other cross-sectional shapes. The male connector 104 includes a male connector housing 103. In this embodiment, the rear end of the male connector housing 103 is provided with external threads, so that the male connector 104 can be threadedly connected to an external pipeline (not shown) via the external threads. In other embodiments, the male connector 104 can also be connected to an external pipeline in other ways, such as by clamp connection, etc. The male connector 104 internally defines a male connector channel 108 passing therethrough. The rear end of the male connector channel 108 is for fluid communication with an external pipeline (not shown), and the front end of the male connector 104 is for insertion into and fixation to the female connector 102.

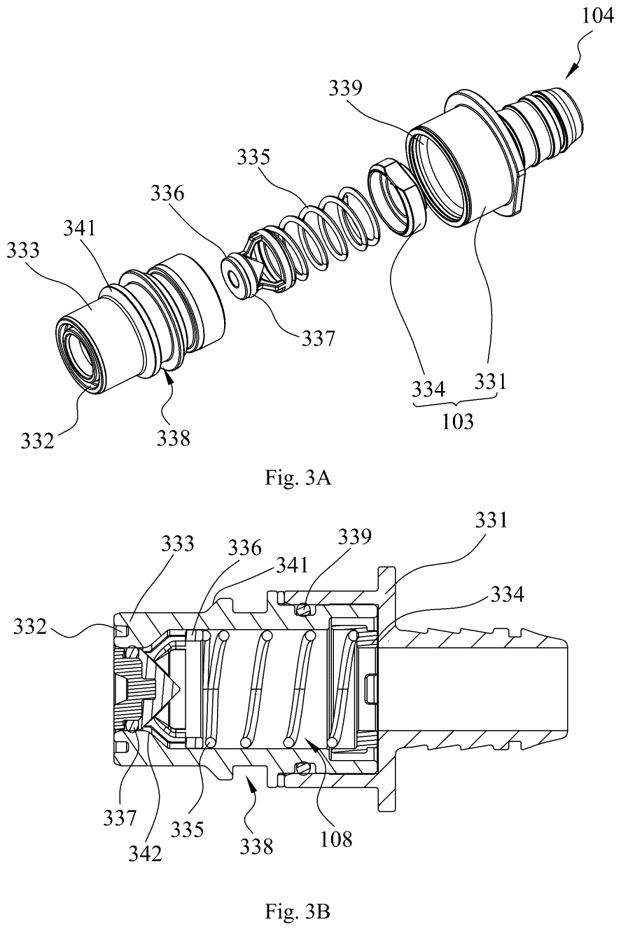

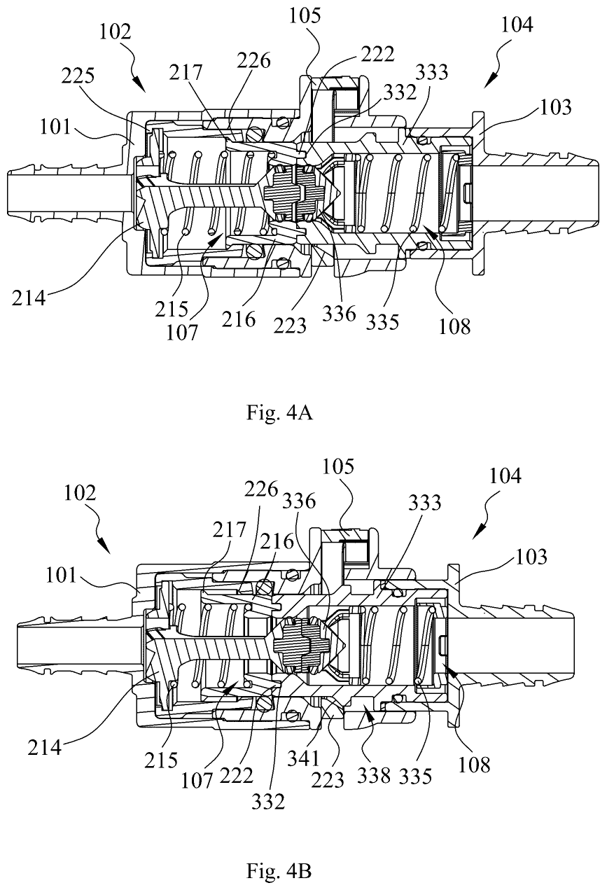

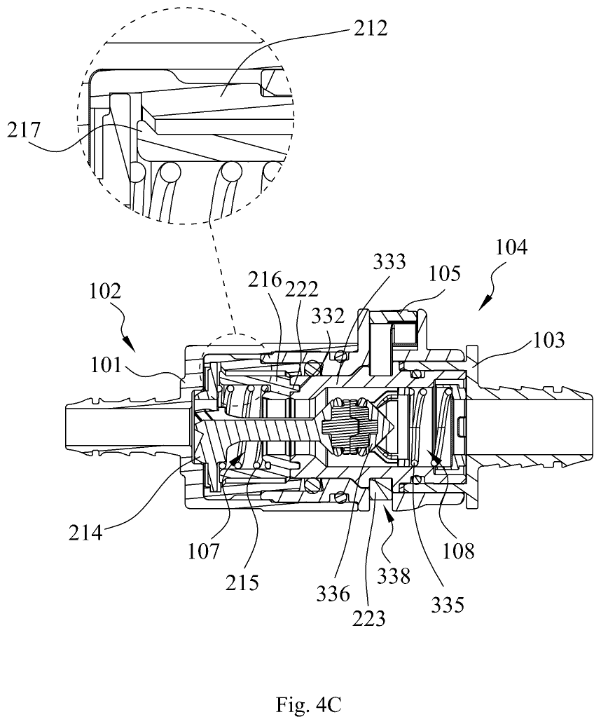

In this embodiment, the female connector 102 further includes a locking element 105. The locking element 105 is inserted into the female connector housing 101 and can move up and down relative to the female connector housing 101. The locking element 105 is for locking the male connector 104 and the female connector 102. Specifically, the male connector 104 is provided with a circumferentially extending groove 338 (see FIGS. 3A and 3B) on the outer surface thereof. In this embodiment, the groove 338 is annular, extending around the periphery of the male connector 104, and is defined between two annular flanges protruding from the male connector 104. In other embodiments, depending on the specific male connector dimensions, the groove can also be formed by a recess in the outer surface of the male connector. The groove 338 is for receiving a locking portion 223 of the locking element 105 of the female connector 102 (see FIG. 4C) to fixedly connect and lock the male connector 104 and the female connector 102 relative to each other. Those skilled in the art will understand that the locking element 105 can be any known structure, as long as a corresponding locked portion (e.g., a groove) is provided on the male connector 104.

The end of the male connector 104 for insertion into the female connector 102 has a guide wall 341 (see FIG. 3A). The guide wall 341 cooperates with the locking portion 223 of the locking element 105 to together guide the male connector 104 to drive the locking element 105 downward when being inserted into the female connector 102. In this embodiment, the guide wall 341 and the locking portion 223 are provided with complementary inclined surfaces. When the male connector 104 is inserted into the female connector 102 under an applied force, the guide wall 341 and the locking portion 223 generate a component force on the contact surface that drives the locking element 105 downward. After the male connector 104 is inserted in place into the female connector 102, the locking element 105 moves upward so that the locking portion 223 inserts into the groove 338, locking the male connector 104 and the female connector 102 relative to each other. In other embodiments, the guide wall 341 and the locking portion 223 can also have other shapes and structures. Furthermore, in other embodiments, locking elements of other structures can be used, as long as they can lockingly connect the male and female connectors.

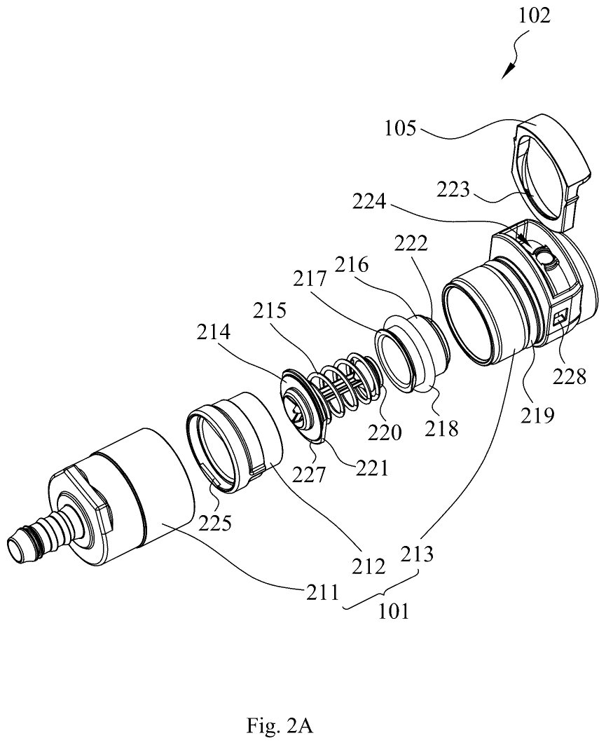

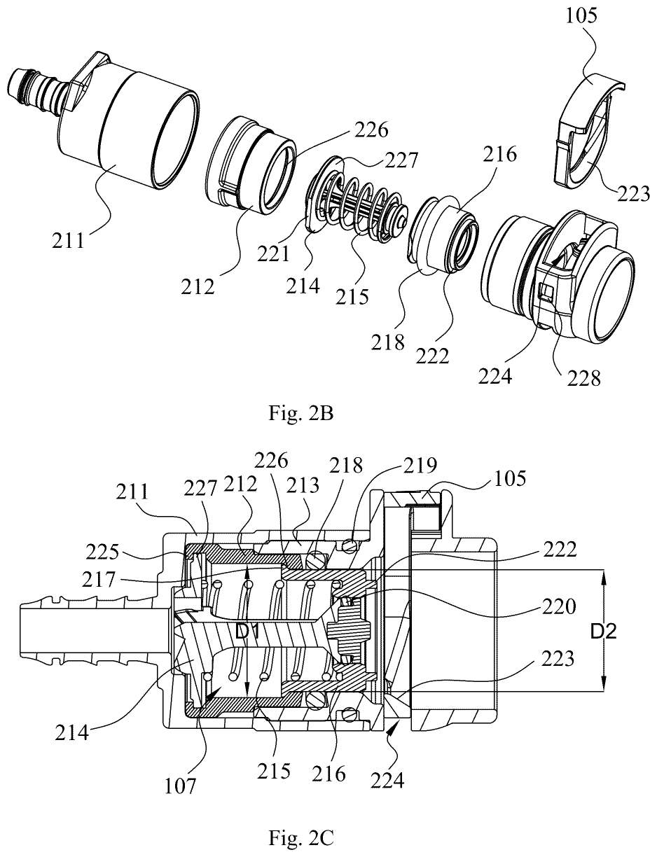

When the female connector 102 has not yet received and fixed the male connector 104, both the female connector channel 107 and the male connector channel 108 are closed (or disconnected), so that the external pipelines connected to the female connector 102 and the male connector 104 are effectively shut off, achieving the bidirectional shut-off function of the bidirectional shut-off connector assembly, i.e., the bidirectional shut-off connector assembly 100 is closed. The specific structure for closing and opening the female connector channel 107 will be described in detail later with reference to FIGS. 2A-2C, and the specific structure for closing and opening the male connector channel 108 will be described in detail later with reference to FIGS. 3A-3B.

After the male connector 104 is inserted into the female connector 102, both the female connector channel 107 and the male connector channel 108 are opened (or connected), and the female connector channel 107 and the male connector channel 108 are in fluid communication, allowing fluid communication between the pipeline connected to the male connector 104 and the pipeline connected to the female connector 102, thus opening the bidirectional shut-off connector assembly 100.

In this embodiment, the female connector 102 and the male connector 104 are generally cylindrical shapes arranged coaxially, giving the bidirectional shut-off connector assembly 100 an axis i. For ease of description, in the present disclosure, the extension direction of the axis i is defined as the axial direction, the direction around the axis i is defined as the circumferential direction, and the direction perpendicular to the axis i is defined as the radial direction. The male connector 104 is inserted into the female connector 102 along the axial direction. In the present disclosure, the insertion direction x of the male connector 104 is defined as the first direction, and the withdrawn direction of the male connector 104 is defined as the second direction, the first and second directions being opposite. Furthermore, in the present disclosure, in the axial direction of the bidirectional shut-off connector assembly 100, the side of the female connector 102 is referred to as the “front,” and the side of the male connector 104 is referred to as the “rear.”

FIGS. 2A-2C show the specific structure of the female connector 102. FIG. 2A and FIG. 2B show perspective exploded views of the female connector 102 from two viewing angles, and FIG. 2C shows an axial cross-sectional view of the female connector 102. As shown in FIGS. 2A-2C, the female connector housing 101 includes a female connector first outer housing 211, a female connector second outer housing 213, and a female connector inner housing 212. The female connector first outer housing 211 and the female connector second outer housing 213 are sealingly connected. In some embodiments, the female connector first outer housing 211 and the female connector second outer housing 213 are welded together. The female connector inner housing 212 is detachably connected inside the female connector first outer housing 211 and the female connector second outer housing 213.

The female connector 102 further includes a female connector inner valve core 214, a female connector outer valve core 216, and a female connector elastic element 215. The female connector outer valve core 216 is for abutting against the male connector outer valve core 333 (see FIG. 4A) along the axial direction, so as to be able to move axially relative to the female connector housing 101 with the axial movement of the male connector outer valve core 333. The female connector housing 101 and the female connector inner valve core 214 together define the female connector channel 107. The female connector outer valve core 216 opens (or connects) or closes (or disconnects) the female connector channel 107 through axial movement.

The female connector elastic element 215 is supported between the female connector inner valve core 214 and the female connector outer valve core 216, and is configured to provide a preload force to the female connector inner valve core 214 and the female connector outer valve core 216. In this embodiment, the female connector elastic element 215 is a spring. When the male connector 104 is not yet inserted into the female connector 102, the spring is in a compressed preloaded state. During insertion of the male connector 104 into the female connector 102, the spring is further compressed. In this embodiment, the female connector inner housing 212 further includes an inner housing blocking portion 225 provided at the front end (i.e., the end away from the male connector 104) and an inner housing limiting portion 226 provided at the rear end (i.e., the end near the male connector 104). The inner housing blocking portion 225 and the inner housing limiting portion 226 are annular protrusions formed by protruding into the female connector channel 107. The inner housing blocking portion 225 abuts against the front portion of the female connector inner valve core 214, and the inner housing limiting portion 226 abuts against the front portion of the female connector outer valve core 216. With the movement of the female connector outer valve core 216, the inner housing limiting portion 226 can abut against the outer surface of the female connector outer valve core 216. Thus, the female connector inner housing 212 can, together with the female connector elastic element 215, retain the female connector inner valve core 214 and the female connector outer valve core 216 in place. In some specific embodiments, the female connector inner housing 212, the female connector elastic element 215, the female connector inner valve core 214, and the female connector outer valve core 216 can be assembled together first, and then assembled together between the female connector first outer housing 211 and the female connector second outer housing 213. This can prevent the connection of the female connector first outer housing 211 and the female connector second outer housing 213 from being affected by the internal elements of the female connector 102. Moreover, after the female connector inner housing 212, female connector elastic element 215, female connector inner valve core 214, and female connector outer valve core 216 are assembled together as a whole, they can be adapted to female connector first and second outer housings 211, 213 of different shapes. In some application scenarios, they can even be adapted to different types of connectors.

More specifically, the female connector outer valve core 216 is generally cylindrical, and it is provided with a limiting flange 217 at the front end thereof. The limiting flange 217 is formed by protruding outward from the cylinder wall at the front end of the female connector outer valve core 216. The inner housing limiting portion 226 of the female connector inner housing 212 includes an annular boss matching the shape of the limiting flange 217. In this embodiment, the inner diameter D1 of the female connector inner housing 212 is greater than the outer diameter D2 of the female connector outer valve core 216. Therefore, the female connector outer valve core 216 can pass through the female connector inner housing 212 from front to rear (i.e., from left to right in FIG. 2C) until the limiting flange 217 of the female connector outer valve core 216 catches on the inner housing limiting portion 226 of the female connector inner housing 212, preventing the female connector outer valve core 216 from detaching from the rear side of the female connector inner housing 212.

The female connector inner valve core 214 is generally rod-shaped with a certain axial length, its axial length set so that its front end can abut against the front end of the female connector inner housing 212, and its rear end can engage with the male connector inner valve core 336 when the male connector 104 is inserted (see FIG. 4B). Its front end is provided with a disk portion 227, the shape and size of which match those of the front end of the female connector inner housing 212. A pair of flat surfaces 221 are provided on opposite sides of the disk portion 227. The inner housing blocking portion 225 of the female connector inner housing 212 includes a pair of bosses matching the shape of the flat surfaces 221. When assembling the female connector inner valve core 214 with the female connector inner housing 212, the pair of flat surfaces 221 of the female connector inner valve core 214 are aligned with the bosses of the inner housing blocking portion 225 of the female connector inner housing 212, and then the female connector inner valve core 214 is pushed from front to rear into the female connector inner housing 212. Then, the female connector inner valve core 214 and the female connector inner housing 212 are rotated relative to each other so that the bosses of the inner housing blocking portion 225 of the female connector inner housing 212 abut against the edge of the disk portion 227, preventing the female connector inner valve core 214 from detaching from the front side of the female connector inner housing 212.

In this embodiment, the female connector outer valve core 216 and the female connector inner housing 212 are assembled together first, then the female connector inner valve core 214 and the female connector elastic element 215 are assembled together into the female connector inner housing 212, with the rear end of the female connector elastic element 215 abutting against the female connector outer valve core 216.

The female connector outer valve core 216 has a female connector closed position (i.e., a female connector first position) and a female connector open position (i.e., a female connector second position). The female connector outer valve core 216 is configured to move axially between the female connector closed position and the female connector open position. FIG. 2C shows the state where the female connector outer valve core 216 is in the female connector closed position. In the state shown in FIG. 2C, the female connector channel 107 is closed (or disconnected). Specifically, the female connector 102 includes a third seal ring 220. In the state shown in FIG. 2C, the third seal ring 220 surrounds the rear end of the female connector inner valve core 214 and sealingly connects between the female connector outer valve core 216 and the female connector inner valve core 214. Thus, the rear side of the female connector channel 107 is closed by the sealingly contacting female connector outer valve core 216 and female connector inner valve core 214, closing (or disconnecting) the female connector channel 107.

When the female connector outer valve core 216 is pushed axially forward by the male connector outer valve core 333 of the male connector 104 to its open position, the female connector outer valve core 216 moves away from the female connector inner valve core 214, causing the third seal ring 220 to no longer sealingly contact the female connector outer valve core 216, thereby opening (or connecting) the female connector channel 107.

In this embodiment, the female connector 102 further includes a first seal ring 218 and a second seal ring 219. When the female connector outer valve core 216 is in the female connector closed position, the first seal ring 218 sealingly connects between the female connector outer valve core 216 and the female connector second outer housing 213. When the female connector outer valve core 216 is in its female connector open position, the first seal ring 218 sealingly connects between the male connector outer valve core 333 and the female connector second outer housing 213 (see FIG. 4C). The second seal ring 219 sealingly connects between the female connector first outer housing 211 and the female connector second outer housing 213. The first and second seal rings 218, 219 can prevent fluid leakage between the female connector housing 101 and the corresponding valve cores.

In the present disclosure, the male connector outer valve core 333 further includes a male connector limiting portion 332, and the female connector outer valve core 216 includes a female connector limiting portion 222. The male connector limiting portion 332 can engage with the female connector limiting portion 222 to restrict movement of the female connector outer valve core 216 relative to the male connector outer valve core 333 in the radial direction. Radial movement here includes movement perpendicular to the axial direction, or wobbling relative to the axial direction, etc. This will be explained in detail later.

In the present disclosure, the female connector second outer housing 213 is provided with an opening 224. The locking element 105 passes through the opening 224 and moves up and down therein. During insertion of the male connector 104 into the female connector 102, the locking element 105 can move downward so that the locking portion 223 avoids the movement path of the male connector 104. After the male connector 104 is inserted in place into the female connector 102, the locking element 105 can move upward into the groove 338 of the male connector 104, thereby lockingly connecting the male connector 104 and the female connector 102. In this embodiment, the female connector second outer housing 213 is further provided with at least one window 228 on a side thereof, and the window 228 is in connection with the opening 224. As the locking element 105 moves up and down, the window 228 exposes or covers specific parts on the locking element 105, such as a QR code area, etc.

FIGS. 3A-3B show the specific structure of the male connector 104. FIG. 3A shows a perspective exploded view of the male connector 104, and FIG. 3B shows an axial cross-sectional view of the male connector 104. As shown in FIGS. 3A-3B, the male connector 104 includes a male connector housing 103, a male connector outer valve core 333, a male connector inner valve core 336, and a male connector elastic element 335. The male connector outer valve core 333 is sealingly connected with the male connector housing 103. The male connector inner valve core 336 can move axially relative to the male connector outer valve core 333 and the male connector housing 103. The male connector housing 103 and the male connector outer valve core 333 together define the male connector channel 108. The male connector inner valve core 336 opens (or connects) or closes (or disconnects) the male connector channel 108 through axial movement.

The male connector housing 103 includes a male connector rear housing 331 and a blocking seat 334. The blocking seat 334 is connected inside the male connector rear housing 331. The male connector elastic element 335 is supported between the blocking seat 334 of the male connector housing 103 and the male connector inner valve core 336, and is configured to provide a preload force to the male connector housing 103 and the male connector inner valve core 336. In this embodiment, the male connector elastic element 335 is also a spring. When the male connector 104 is not yet inserted into the female connector 102, the spring is in a compressed preloaded state. During insertion of the male connector 104 into the female connector 102, the spring is further compressed. The male connector inner valve core 336 is inside the male connector outer valve core 333. In this embodiment, the front end of the male connector outer valve core 333 is provided with a male connector blocking portion 342, which protrudes into the male connector channel 108. The male connector inner valve core 336 is configured to have a shape matching the male connector blocking portion 342 of the male connector outer valve core 333 to prevent the male connector inner valve core 336 from detaching from the front side of the male connector outer valve core 333, but does not restrict rearward movement of the male connector inner valve core 336. The rear side of the male connector outer valve core 333 is restricted by the male connector rear housing 331 and the blocking seat 334 to support the male connector elastic element 335.

In this embodiment, the male connector inner valve core 336 has a male connector closed position (i.e., a male connector first position) and a male connector open position (i.e., a male connector second position). The male connector inner valve core 336 is configured to move axially between the male connector closed position and the male connector open position. FIG. 3B shows the state where the male connector inner valve core 336 is in the male connector closed position. In the state shown in FIG. 3B, the male connector channel 108 is closed (or disconnected). Specifically, the male connector 104 includes a fourth seal ring 337. In the state shown in FIG. 3B, the fourth seal ring 337 surrounds the front end of the male connector outer valve core 333 and sealingly connects between the male connector outer valve core 333 and the male connector inner valve core 336. Thus, the front side of the male connector channel 108 is closed by the sealingly contacting male connector outer valve core 333 and male connector inner valve core 336, closing (or disconnecting) the male connector channel 108.

When the male connector inner valve core 336 is pushed axially rearward by the female connector inner valve core 214 to its open position, the male connector inner valve core 336 moves away from the male connector outer valve core 333, causing the fourth seal ring 337 to no longer sealingly contact the male connector outer valve core 333, thereby opening (or connecting) the male connector channel 108.

In this embodiment, the male connector 104 further includes a fifth seal ring 339, which sealingly connects between the male connector rear housing 331 and the male connector outer valve core 333. The fifth seal ring 339 can prevent fluid leakage between the male connector housing 103 and the corresponding valve core.

In some embodiments, the male connector limiting portion 332 is provided on the axial end of the male connector outer valve core 333 facing the female connector outer valve core 216, for example, on the end surface of the axial end. The female connector limiting portion 222 is provided on the axial end of the female connector outer valve core 216 facing the male connector outer valve core 333, for example, on the end surface of the axial end. The male connector limiting portion 332 and the female connector limiting portion 222 of the female connector outer valve core 216 are configured to have matching shapes, so that when the male connector outer valve core 333 moves axially in the first direction (i.e., the insertion direction), the male connector limiting portion 332 and the female connector limiting portion 222 remain engaged, and when the male connector outer valve core 333 moves axially in the second direction opposite the first direction (i.e., the withdrawn direction), the male connector limiting portion 332 is allowed to disengage from the female connector limiting portion 222. Thus, in the insertion direction, the male connector outer valve core 333 and the female connector outer valve core 216 can move together along the insertion direction x. But in the withdrawn direction, the male connector outer valve core 333 can separate from the female connector outer valve core 216.

In some embodiments, the female connector limiting portion 222 and the male connector limiting portion 332 are configured as mating protruding and recessed structures. One of the female connector limiting portion 222 and the male connector limiting portion 332 has a protruding shape, e.g., including at least one protrusion, and the other has a recessed shape, e.g., including at least one groove. The groove can at least partially accommodate the protrusion. In some embodiments, the at least one protrusion is formed to protrude axially, and the at least one groove is formed to be recessed axially. Through the axially mating structure of protrusion and groove, the male connector outer valve core 333 can better retain the female connector outer valve core 216 axially. The protrusion height of the at least one protrusion and the recess depth of the at least one groove are set so that the male connector outer valve core 333 can retain the female connector outer valve core 216 axially.

In some embodiments, one of the female connector limiting portion 222 and the male connector limiting portion 332 is an annular protrusion, and the other is an annular groove. In this embodiment, the female connector limiting portion 222 includes a continuously extending annular protrusion protruding axially rearward from the end of the female connector outer valve core 216, and the male connector limiting portion 332 includes a continuously extending annular groove recessed axially rearward from the end of the male connector outer valve core 333. The annular protrusion and annular groove have square cross-sectional shapes. In other embodiments, the annular flange and annular groove can also be configured to have triangular, sawtooth, or trapezoidal cross-sections, or any other shape. Those skilled in the art will understand that the at least one protrusion can also be configured as multiple protrusions arranged circumferentially or multiple protrusions spaced radially, and the at least one groove can also be configured as multiple grooves arranged circumferentially or multiple grooves spaced radially. Furthermore, those skilled in the art will understand that the male connector limiting portion and the female connector limiting portion can also be configured with other mating shapes, as long as they can restrict the female connector outer valve core 216 from moving radially relative to the male connector outer valve core 333, and can maintain engagement of the male and female connector limiting portions in the first direction, while allowing disengagement in the second direction.

In the present disclosure, since the male connector outer valve core 333 is fixedly connected to the male connector housing 103, during axial insertion of the male connector 104, it can be ensured that the male connector outer valve core 333 moves axially. And since the inner diameter D1 of the female connector inner housing 212 is greater than the outer diameter D2 of the female connector outer valve core 216, when the female connector outer valve core 216 moves axially to a certain position, a gap will exist between the female connector inner housing 212 and the female connector outer valve core 216, causing the female connector outer valve core 216 to no longer be retained axially by the female connector housing 101. Without the male and female connector limiting portions, the female connector outer valve core 216 would easily undergo radial movement, such as movement perpendicular to the axial direction or wobbling relative to the axial direction. If the female connector outer valve core 216 undergoes radial movement, after the male connector outer valve core 333 no longer abuts the female connector outer valve core 216, the female connector outer valve core 216 will be unable to return to the female connector closed position under the action of the female connector elastic element 215.

Moreover, without the male and female connector limiting portions, to prevent radial movement of the female connector outer valve core 216, the contact distance between the female connector housing and the female connector outer valve core 216 would need to be increased, i.e., the size of the female connector housing would need to be increased for a given travel of the female connector outer valve core 216.

The present disclosure, by providing the male and female connector limiting portions, uses the male connector outer valve core 333 to restrict radial movement of the female connector outer valve core 216, so that even when the female connector outer valve core 216 moves to a certain position where it no longer contacts and is limited by the female connector housing 101, radial movement does not occur. When the male connector outer valve core 333 moves in the second direction away from the female connector outer valve core 216, the female connector outer valve core 216 can, under the guidance and restriction of the male and female connector limiting portions and under the action of the female connector elastic element 215, return axially to the female connector closed position, reclosing the female connector channel 107. This not only increases the reliability of the connector assembly but also reduces its size.

FIGS. 4A-4C show axial cross-sectional views of the bidirectional shut-off connector assembly at different positions during insertion of the male connector 104 into the female connector 102. FIG. 4A shows an axial cross-sectional view of the bidirectional shut-off connector assembly 100 when the male connector 104 has not yet been inserted into the female connector 102. FIG. 4B shows an axial cross-sectional view of the bidirectional shut-off connector assembly 100 during insertion of the male connector 104 into the female connector 102. FIG. 4C shows an axial cross-sectional view of the bidirectional shut-off connector assembly 100 after the male connector 104 is inserted in place into the female connector 102. The movement of the male connector outer valve core 333 in the first direction can open the bidirectional shut-off connector assembly 100 in the sequence shown in FIGS. 4A-4C, and the movement of the male connector outer valve core 333 in the second direction can close the bidirectional shut-off connector assembly 100 in the sequence shown in FIGS. 4C-4A.

As shown in FIG. 4A, the male connector 104 has not yet been inserted into the female connector 102. The female connector outer valve core 216 of the female connector 102 is in the female connector closed position. The female connector inner valve core 214 and the female connector outer valve core 216 sealingly contact to close the female connector channel 107. The female connector elastic element 215 abuts between the female connector outer valve core 216 and the female connector inner valve core 214 and applies an axial preload force to them. The inner housing blocking portion 225 of the female connector housing 101 abuts against the front side of the female connector inner valve core 214, and the inner housing limiting portion 226 of the female connector housing 101 abuts against the limiting flange 217 on the front side of the female connector outer valve core 216, to retain the female connector inner valve core 214 and the female connector outer valve core 216 in place, closing the female connector channel 107.

The male connector inner valve core 336 of the male connector 104 is in the male connector closed position. The male connector inner valve core 336 and the male connector outer valve core 333 sealingly contact to close the male connector channel 108. The male connector elastic element 335 abuts between the male connector inner valve core 336 and the male connector housing 103 and applies an axial preload force to them. The male connector outer valve core 333 and the male connector elastic element 335 retain the male connector inner valve core 336 in place, closing the male connector channel 108. The locking element 105 is in an upper position, with the locking portion 223 blocking the insertion path of the male connector 104.

In this state, the front end of the male connector outer valve core 333 abuts the rear end of the female connector outer valve core 216, and the female connector limiting portion 222 is accommodated in the male connector limiting portion 332, but the male connector 104 has not yet been inserted into the female connector 102, so the male connector outer valve core 333 has not yet pushed the female connector outer valve core 216. As the operator pushes the male connector 104 from rear to front (i.e., from right to left in FIG. 4A or the first direction), the male connector outer valve core 333 pushes the female connector outer valve core 216, compressing the female connector elastic element 215. As the male connector 104 moves forward, the male connector inner valve core 336 abuts against the female connector inner valve core 214. The female connector inner valve core 214 pushes the male connector inner valve core 336 rearward, compressing the male connector elastic element 335, and the male connector inner valve core 336 leaves the male connector closed position, until reaching the position shown in FIG. 4B.

As shown in FIG. 4B, during insertion of the male connector 104 into the female connector 102, the female connector outer valve core 216 has left the female connector closed position but has not yet reached the open position. The female connector inner valve core 214 no longer sealingly contacts the female connector outer valve core 216 but sealingly contacts the male connector outer valve core 333, so the female connector channel 107 remains closed. The female connector elastic element 215 is compressed. The limiting flange 217 of the female connector outer valve core 216 has left the inner housing limiting portion 226 of the female connector housing 101, but the outer surface of the female connector outer valve core 216 still contacts the inner housing limiting portion 226, so the female connector outer valve core 216 does not undergo radial movement.

The male connector inner valve core 336 of the male connector 104 has left the male connector closed position but has not yet reached the male connector open position. The male connector inner valve core 336 no longer sealingly contacts the male connector outer valve core 333, partially opening the male connector channel 108. As the male connector 104 moves forward, the male connector elastic element 335 is compressed. The groove 338 of the male connector 104 is not yet aligned with the locking portion 223 of the locking element 105, which still blocks the insertion path of the male connector 104 and is about to contact the guide wall 341 of the male connector 104.

In this state, the front end of the male connector outer valve core 333 still abuts the rear end of the female connector outer valve core 216, and the female connector limiting portion 222 is still accommodated in the male connector limiting portion 332. The front end of the male connector inner valve core 336 abuts the rear end of the female connector inner valve core 214. As the operator further pushes the male connector 104 from rear to front (i.e., from right to left in FIG. 4B, along the first direction), the guide wall 341 of the male connector 104 pushes the locking portion 223 of the locking element 105 via complementary inclined surfaces, causing the locking element 105 to move downward. As the locking element 105 moves downward, the locking portion 223 withdraws from the insertion path of the male connector 104, allowing the male connector 104 to continue inserting into the female connector 102 along the first direction. The male connector outer valve core 333 further pushes the female connector outer valve core 216, further compressing the female connector elastic element 215. The female connector inner valve core 214 further pushes the male connector inner valve core 336 rearward, and the male connector elastic element 335 is further compressed, until reaching the position shown in FIG. 4C.

As shown in FIG. 4C, after the male connector 104 is inserted in place into the female connector 102, the groove 338 of the male connector 104 aligns with the locking portion 223 of the locking element 105. The locking element 105 moves upward so that the locking portion 223 inserts into the groove 338, locking the relative positions of the male connector 104 and the female connector 102. In this state, the female connector outer valve core 216 reaches the open position. The female connector inner valve core 214 neither sealingly contacts the female connector outer valve core 216 nor the male connector outer valve core 333, so the female connector channel 107 is opened. The female connector elastic element 215 is compressed to its shortest length, providing an elastic force to the female connector outer valve core 216 for driving it rearward. The female connector outer valve core 216 has completely left the female connector inner housing 212 of the female connector housing 101, but the female connector limiting portion 222 of the female connector outer valve core 216 is retained in place by the male connector limiting portion 332 of the male connector outer valve core 333, preventing radial movement of the female connector outer valve core 216.

The male connector inner valve core 336 of the male connector 104 reaches the male connector open position. The male connector inner valve core 336 is separated from the male connector outer valve core 333 by a certain distance, fully opening the male connector channel 108. The male connector elastic element 335 is compressed to its shortest length, providing an elastic force to the male connector inner valve core 336 for driving it forward.

In this state, both the female connector channel 107 and the male connector channel 108 are opened and in fluid communication, allowing fluid communication between the pipeline connected to the male connector 104 and the pipeline connected to the female connector 102. The bidirectional shut-off connector assembly 100 is opened.

When it is necessary to close the bidirectional shut-off connector assembly 100, i.e., to shut off the pipelines connected to the male connector 104 and the female connector 102, the operator presses the locking element 105, causing the locking portion 223 to withdraw from the groove 338 of the male connector 104. The operator can withdraw the male connector 104 from the female connector 102 from front to rear along the second direction. The front side of the male connector inner valve core 336 of the male connector 104 is no longer abutted by the female connector inner valve core 214, so under the elastic force of the male connector elastic element 335, it moves axially to the male connector closed position, closing the male connector channel 108. The female connector limiting portion 222 of the female connector outer valve core 216 is guided by the male connector limiting portion 332 of the male connector outer valve core 333. Therefore, as the male connector 104 is withdrawn along the second direction, the female connector outer valve core 216, under the elastic force of the female connector elastic element 215, also moves axially to the female connector closed position, closing the female connector channel 107.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### Main Reference Signs

100 Bidirectional shut-off connector assembly
101 Female connector housing
102 Female connector
103 Male connector housing
104 Male connector
105 Locking element
107 Female connector channel
108 Male connector channel
211 Female connector first outer housing
212 Female connector inner housing
213 Female connector second outer housing
214 Female connector inner valve core
215 Female connector elastic element
216 Female connector outer valve core
217 Limiting flange
218 First seal ring
219 Second seal ring
220 Third seal ring
221 Flat surface
222 Female connector limiting portion
223 Locking portion
224 Opening
225 Inner housing blocking portion
226 Inner housing limiting portion
227 Disk portion
228 Window
331 Male connector rear housing
332 Male connector limiting portion
333 Male connector outer valve core
334 Blocking seat
335 Male connector elastic element
336 Male connector inner valve core
337 Fourth seal ring
338 Groove
339 Fifth seal ring
341 Guide wall
342 Male connector blocking portion

What is claimed is:

1. A connector assembly, the connector assembly having an axial direction and a radial direction and comprising:
a male connector comprising a male connector outer valve core; and
a female connector comprising a female connector outer valve core, the female connector outer valve core abutting against the male connector outer valve core along the axial direction,
wherein the male connector outer valve core has a male connector limiting portion, the female connector outer valve core has a female connector limiting portion, and the male connector limiting portion is configure to engage with the female connector limiting portion.

2. The connector assembly according to claim 1, wherein the connector assembly is a two-way shut-off connector assembly.

3. The connector assembly according to claim 1, wherein the female connector limiting portion is provided at an axial end of the female connector outer valve core facing the male connector outer valve core, and the male connector limiting portion is provided at an axial end of the male connector outer valve core facing the female connector outer valve core.

4. The connector assembly according to claim 3, wherein the female connector limiting portion is provided at an end surface of the axial end of the female connector outer valve core, and the male connector limiting portion is provided at an end surface of the axial end of the male connector outer valve core.

5. The connector assembly according to claim 1, wherein one of the female connector limiting portion and the male connector limiting portion has a protruding shape, and the other of the female connector limiting portion and the male connector limiting portion has a recessed shape.

6. The connector assembly according to claim 1, wherein one of the female connector limiting portion and the male connector limiting portion is an annular protrusion, and the other of the female connector limiting portion and the male connector limiting portion is an annular groove.

7. The connector assembly according to claim 1, wherein the female connector comprises a female connector housing, the female connector housing comprising a female connector first outer housing, a female connector second outer housing, and a female connector inner housing, the female connector first outer housing and the female connector second outer housing being connected together, and the female connector inner housing is detachably connected inside the female connector first outer housing and the female connector second outer housing; and
wherein the female connector outer valve core is inside the female connector inner housing.

8. The connector assembly according to claim 7, wherein the female connector inner housing has an inner housing limiting portion provided at an end of the female connector inner housing close to the male connector and capable of abutting against an outer surface of the female connector outer valve core.

9. The connector assembly according to claim 8, wherein the inner housing limiting portion is an annular protrusion.

10. An energy storage device comprising the connector assembly according to claim 1.

11. A connector assembly extending along an axial direction and having a radial direction, the connector assembly comprising:
a male connector including a male outer valve core; and
a female connector including a female outer valve core movable along the axial direction relative to the male outer valve core and configured to contact the male outer valve core when the male connector and the female connector are coupled;
the male outer valve core including a first limiting structure and the female outer valve core including a second limiting structure positioned to engage the first limiting structure when the male connector and the female connector are coupled,
the first and second limiting structures cooperating to restrict radial displacement of the female outer valve core relative to the male outer valve core.

12. The connector assembly of claim 11, wherein the first limiting structure and the second limiting structure are positioned at opposing axial end regions of the male outer valve core and the female outer valve core.

13. The connector assembly of claim 11, wherein one of the first limiting structure and the second limiting structure includes a protrusion and the other includes a complementary recess configured to receive the protrusion.

14. The connector assembly of claim 13, wherein the protrusion is an annular protrusion and the recess is an annular groove.
